(19) United States
(12) Patent Application Publication
(10) Pub. No.: US 2007/0290619 A1
(43) Pub. Date: Dec. 20, 2007

(54) Plasma display panel device

(76) Inventor: Tae-Kyoung Kang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/812,426

(22) Filed: Jun. 19, 2007

(30) Foreign Application Priority Data
Jun. 20, 2006 (KR) 10-2006-0055407

(51) Int. Cl. H01J 17/49

(52) U.S. Cl. 313/583; 313/582

(57) ABSTRACT

Exemplary embodiments relate to a plasma display panel device, including a substrate, discharge electrodes arranged on the substrate, and a plurality of short-circuit preventing units formed between terminals of each of the discharge electrodes, so as to prevent a short circuit between the terminals of adjacent discharge electrodes.

### BACKGROUND OF THE INVENTION

1. Field of the Invention

Exemplary embodiments relate to a plasma display panel (PDP) device.

2. Description of the Related Art

PDP display devices may display numbers, characters, and/or graphics by applying a discharge voltage to a discharge gas between two substrates with a plurality of electrodes formed on the substrates to generate ultraviolet (UV) light, and then excite phosphor with the UV light.

Such PDP devices may be classified as a direct current (DC) type or an alternating current (AC) type depending on the type of discharge voltages applied to discharge cells, e.g., discharge types. PDP devices may also be classified as a facing discharge type or a surface discharge type depending on the configuration of electrodes.

A three-electrode surface discharge type PDP device may include a first substrate, a second substrate, sustain discharge electrode pairs including X electrodes and Y electrodes arranged on the first substrate, a first dielectric layer in which the sustain discharge electrode pairs may be buried, a protection layer formed on a surface of the first dielectric layer, address electrodes arranged on the second substrate and intersecting the sustain discharge electrode pairs, a second dielectric layer in which the address electrodes may be buried, barrier ribs arranged between the first and second substrates, and red, green, and blue phosphor layers within the barrier ribs.

The sustain discharge electrode pairs may be divided into groups, and the address electrodes may also be divided into groups. The electrode groups may be connected with ports of a signal transferring unit, such as, flexible printed cables.

Further, when an electrical signal is applied to the address electrodes and the Y electrodes in a three-electrode facing discharge type PDP device, discharge cells that emit light may be selected. Moreover, when an electrical signal is alternately applied to the X electrodes and the Y electrodes, visible light may be emitted from a phosphor material of the phosphor within the selected discharge cells, so that a still image or a moving image may be displayed.

As PDP devices become larger, intervals between terminals of the address electrodes may decrease. However, the address electrodes may include silver (a major component of the address electrodes), which may be easily ionized by humidity in the air, and thus, possibly create a short circuit between adjacent electrodes.

### SUMMARY OF THE INVENTION

Example embodiments are therefore directed to a plasma display panel device, which substantially overcome one or more of the problems due to the limitations and disadvantages of the related art.

It is therefore a feature of the exemplary embodiments to provide a plasma display panel device having an improved structure to prevent and/or reduce a short circuit between discharge electrodes.

At least one of the above and other features of example embodiments may provide a plasma display panel device, including a substrate, discharge electrodes arranged on the substrate, and a plurality of short-circuit preventing units formed between terminals of each of the discharge electrodes, so as to prevent a short circuit between the terminals of adjacent discharge electrodes.

At least one of the above and other features of example embodiments may provide a plasma display panel device, including a panel having a first substrate and a second substrate, a plurality of discharge electrode pairs between the first and second substrates, signal transferring units electrically connected to terminals of the discharge electrode pairs, and short-circuit preventing units formed between the terminals of each of the discharge electrodes in order to prevent a short circuit between the terminals of adjacent discharge electrodes. The panel may be divided into a display area that displays an image due to discharge of the discharge electrodes pairs, and a non-display area outside the display area. The non-display area may include the terminals of the discharge electrodes pairs that electrically connect to the terminals of the signal transferring units.

### BRIEF DESCRIPTION OF THE DRAWINGS

The above and other features and advantages of exemplary embodiments will become more apparent to those of ordinary skill in the art by describing in detail exemplary embodiments thereof with reference to the attached drawings, in which:

FIG. 1 illustrates an exploded perspective view of a portion of a plasma display panel (PDP) according to an exemplary embodiment;

FIG. 2 illustrates a plan view of the PDP of FIG. 1 in which a signal transferring unit is attached;

FIG. 3 illustrates an enlarged cross-sectional view of an area where electrode terminals and the signal transferring unit shown in FIG. 2 are attached together;

FIG. 4 illustrates a cross-sectional view of a connecting member shown in FIG. 3 according to an exemplary embodiment;

FIG. 5 illustrates a cross-sectional view of another exemplary embodiment of the connecting member shown in FIG. 3;

FIG. 6 illustrates a plan view of an enlarged area arrangement of short-circuit preventing units according to an exemplary embodiment;

FIG. 7 illustrates a plan view of an enlarged area arrangement of short-circuit preventing units according to another exemplary embodiment;

FIG. 8 illustrates a plan view of an enlarged area arrangement of short-circuit preventing units according to another exemplary embodiment; and

FIG. 9 illustrates a plan view of an enlarged area arrangement of short-circuit preventing units according to another exemplary embodiment.

### DETAILED DESCRIPTION OF THE INVENTION

Korean Patent Application No. 10-2006-0055407, filed on Jun. 20, 2006, in the Korean Intellectual Property Office, and entitled: “Plasma Display Panel Device,” is incorporated by reference herein in its entirety.

Example embodiments will now be described more fully hereinafter with reference to the accompanying drawings. Exemplary embodiments may, however, be embodied in different forms and should not be construed as limited to the embodiments set forth herein. Rather, these example embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. It will also be understood that the term “phosphor” is intended to generally refer to a material that can generate visible light upon excitation by ultraviolet light that impinges thereon, and is not intended be limited to materials the undergo light emission through any particular mechanism or over any particular time frame. Like reference numerals refer to like elements throughout.

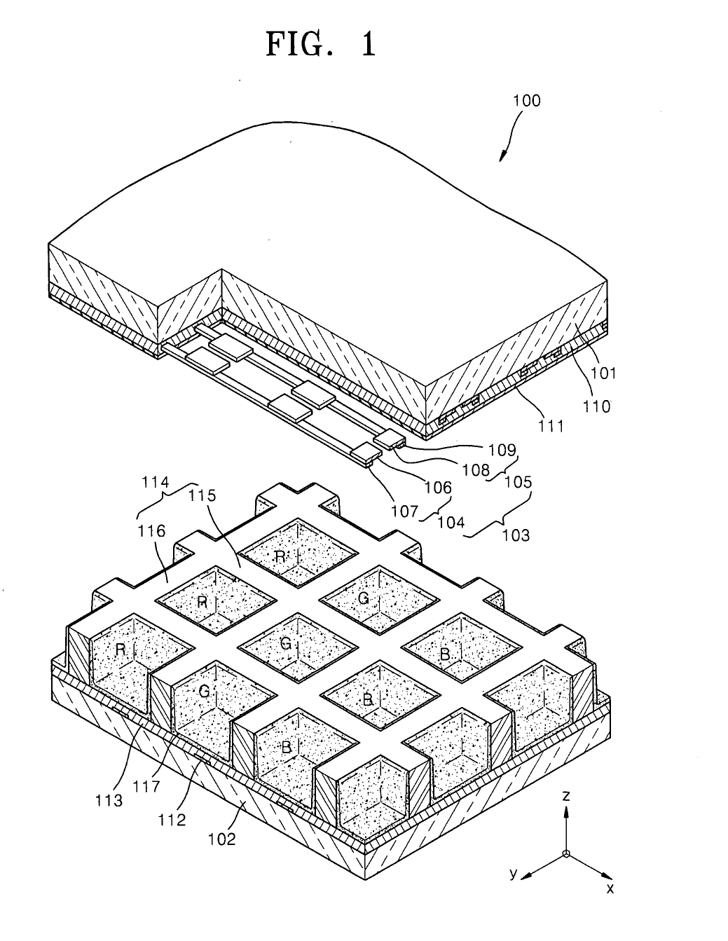

FIG. 1 illustrates an exploded perspective view of a portion of a three-electrode surface discharge plasma display panel (PDP) 100 according to an exemplary embodiment. Referring to FIG. 1, the PDP 100 may include a first substrate 101 and a second substrate 102 parallel to the first substrate 101. Frit glass (not shown) may be provided along edges of inner surfaces of the first substrate 101 and the second substrate 102 that face each other so as to form an enclosed discharge space.

The first substrate 101 may be, for example, but not limited to, a semi-transmissive substrate, a reflective substrate, a colored substrate, or a transparent substrate, e.g., soda lime glass.

Sustain discharge electrode pairs 103 may be arranged on an inner surface of the first substrate 101. Each of the sustain discharge electrode pairs 103 may include an X electrode 104 and a Y electrode 105. A pair of X electrode 104 and Y electrode 105 may be arranged in each discharge cell.

Each of the X electrodes 104 may include a first transparent electrode 106 independently arranged within each discharge cell and a first bus electrode line 107, which may extend along an array of discharge cells arranged in direction X and may electrically connect the first transparent electrodes 106 to one another.

Each of the Y electrodes 105 may include a second transparent electrode 108 independently arranged within each discharge cell and a second bus electrode line 109 which may extend along an array of discharge cells arranged in direction X and may electrically connect the second transparent electrodes 108 to one another.

Each of the first and second transparent electrodes 106 and 108 may have a substantially rectangular horizontal cross-section. It should be appreciated that the transparent electrodes 106 and 108 may be formed in other shapes. The first transparent electrodes 106 do not contact each other and may be arranged at regular intervals to form discharge gaps. Similarly, the second transparent electrodes 108 do not contact each other and may be arranged at regular intervals to form discharge gaps. The first and second bus electrode lines 107 and 109 may be arranged on both edges of facing surfaces of the discharge cells and may be in the shape of strips, for example.

Each of the first and second transparent electrodes 106 and 108 may be a transparent conductive film, such as, but not limited to, an ITO film. The first and second bus electrode lines 107 and 108 may be formed of, for example, a silver paste which may provide excellent conductivity. It should be appreciated that first and second bus electrode lines 107 and 108 may be formed from other metals, such as, chrome-copper-chrome.

The X and Y electrodes 104 and 105 may be positioned within (e.g., buried) in the first dielectric layer 110. The first dielectric layer 110 may be formed of a transparent high-dielectric material, such as, but not limited to, PbO—B₂O₃—SiO₂.

A protection layer 111 may be formed of, such as, but not limited to, magnesium oxide (MgO) on a surface of the first dielectric layer 110 in order to increase secondary electron emissions.

The second substrate 102 may be at least one of a transparent substrate, a semi-transmissive substrate, a reflective substrate, and a colored substrate. One skilled in the art should appreciate that other substrates besides the ones mentioned above may be employed. Address electrodes 112 may be arranged on the inner surface of the second substrate 102 and may intersect the Y electrodes 105.

Each of the address electrodes 112 may extend across each array of discharge cells adjacent to each other in the Y-direction, and may be in a shape of a strip. The address electrodes 102 may be positioned within (e.g., buried) in a second dielectric layer 113. The second dielectric layer 113 may be formed of a high dielectric material similarly used to form the first dielectric layer 110.

A barrier rib structure 114 may be arranged between the first and second substrates 101 and 102. The barrier rib structure 114 may define discharge cells and may prevent and/or reduce a crosstalk between adjacent discharge cells.

The barrier rib structure 114 may include first barrier ribs 115 arranged in a X direction of the PDP 100, and second barrier ribs 116 arranged in a Y direction of the PDP 100. The barrier rib structure 114 may define a matrix-type discharge space.

It should be appreciated that the barrier rib structure 114 may not be limited to the above exemplary embodiment as long as the structure defines discharge cells. It should further be appreciated that the horizontal cross-section of each of the discharge cells may not only be rectangular shaped, but may also have other various shapes, such as, but not limited to, a polygon other than a rectangle, a circle, and an oval.

A discharge gas, such as, but not limited to, Ne—Xe or He—Xe, may be injected into the discharge space defined by the first and second substrates 101 and 102 and the barrier rib-like structure 114.

A plurality of phosphor layers 117, which may be excited by UV light generated from the discharge gas, and thus emitting visible light, may be formed within the discharge cells. Each of the phosphor layers 117 may be formed on any area of each of the discharge cells. In an exemplary embodiment, each of the phosphor layers 117 may cover an upper surface of the second dielectric layer 113 and inside lateral surfaces of the discharge cells.

Although the phosphor layers 117 may include red, green, and blue phosphor layers, exemplary embodiments may not be limited to this composition. In an exemplary embodiment, the red phosphor layers may be formed of (Y,Gd)BO₃;Eu⁺³, the green phosphor layers may be formed of Zn₂SiO₄:Mn²⁺, and the blue phosphor layers may be formed of BaMgAl₁₀O₁₇:Eu²⁺.

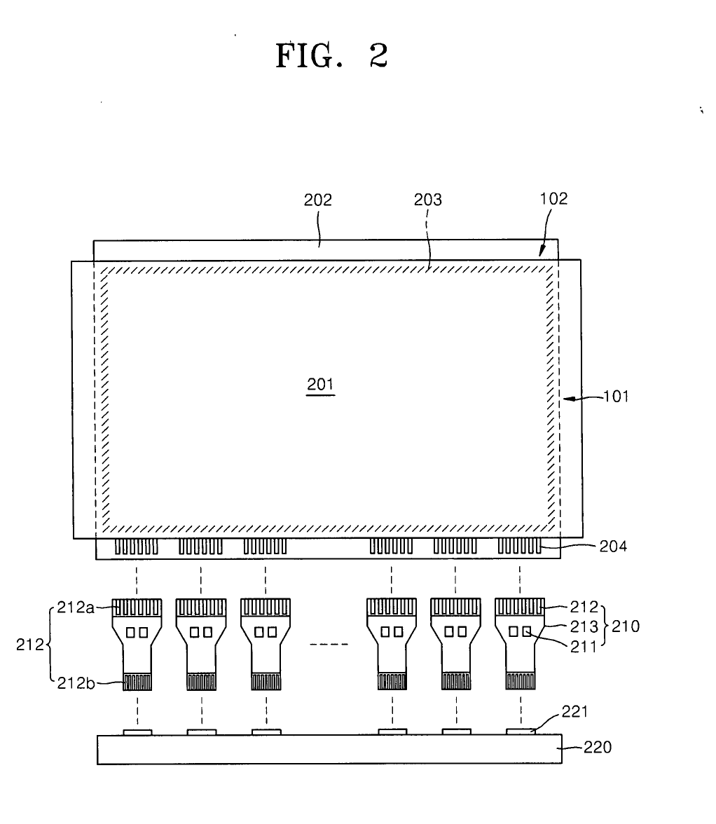

FIG. 2 illustrates a plan view of the PDP 100 of FIG. 1 in which a signal transferring unit may be attached. Referring to FIG. 2, the PDP 100 may be divided into a display area 201 where the first and second substrates 101 and 102 overlap with each other, and a non-display area 202 exposed on outside edges of the display area 201. A frit glass 203 may be provided on a boundary between the display area 201 and the non-display area 202, and may enclose the display area 201.

The display area 201 may display images during discharge. The non-display area 202 may be an area where electrode terminals 204 may be electrically connected to terminals of signal transferring units 210.

The electrode terminals 204 may be juxtaposed on the non-display area 202. In an exemplary embodiment, depending on the way of patterning discharge electrodes, the electrode terminals 204 may be arranged on at least one of a shorter edge and a longer edge of the PDP 100. It should be appreciated that the patterning of the discharge electrodes may be arranged in other various configurations.

As the PDP 100 becomes larger, the use of a single electrode terminal 204 and a single signal transferring unit 210 may be difficult. Accordingly, the electrode terminals 204 may be grouped and the grouped electrode terminals may be connected to the corresponding signal transferring units 210.

One end of the signal transferring units 210 may be electrically connected to the electrode terminals 204 and the other end may be electrically connected to connectors 221 of a driving circuit 220. In an exemplary embodiment, each of the signal transferring units 210 may include a plurality of driving ICs 211, a wiring 212 patterned to be connected to the driving ICs 211, and an elastic film 213 in which the wiring 212 may be entirely or substantially covered. The wiring 212 may include first terminals 212a electrically connected to the electrode terminals 204, and second terminals 212b electrically connected to the connectors 221.

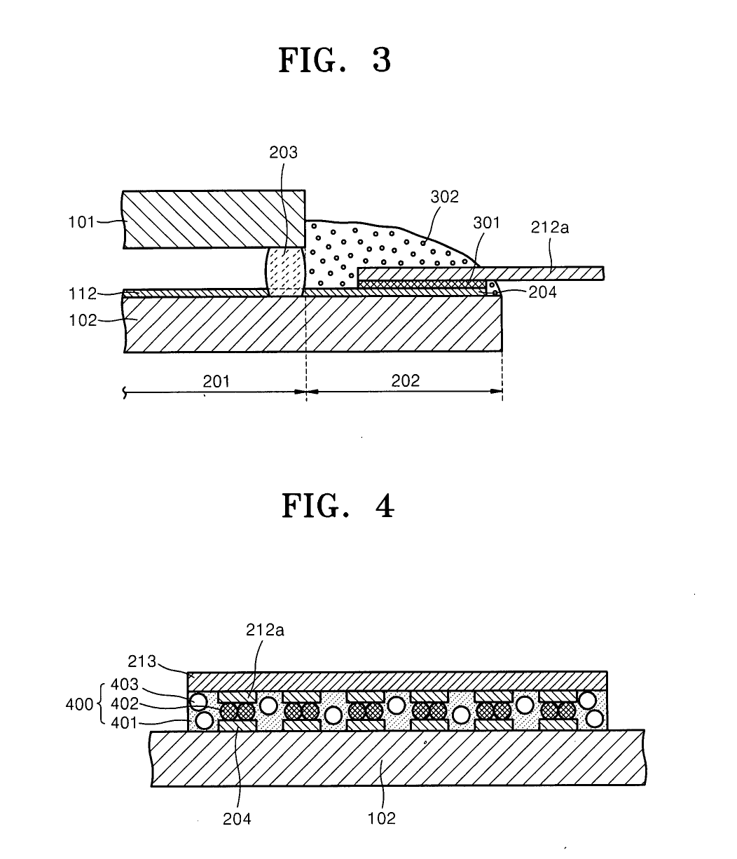

FIG. 3 illustrates an enlarged cross-sectional view of an area where the signal transferring units 210 may be attached to the electrode terminals 204. Referring to FIG. 3, the frit glass 203 may be disposed along an edge between the display area 201 and the non-display area 202. Because the frit glass 203 may be attached and fused to the first and second substrates 101 and 102, the display area 201 may be enclosed.

The address electrodes 112 may be arranged on an upper surface of the second substrate 102. The address electrodes 112 may extend beyond the display area 201 and may be connected to the electrode terminals 204 in the non-display area 202.

The first terminals 212a may be arranged on the electrode terminals 204. A connecting member 301 may be interposed between the electrode terminals 204 and the first terminals 212a in order to transfer an electrical signal between the address electrodes 204 and the driving circuit unit 220 of FIG. 2.

The connecting member 301 may be formed of a material that may electrically connect the electrode terminals 204 with the first terminals 212a. For example, the connecting member 301 may be an anisotropic conductive film (ACF) 400, as illustrated in FIG. 4.

In the ACF 400, a plurality of ball-shaped conductive particle layers 402 may be scattered within a polymer resin adhering layer 401, and insulative members 403 may be distributed in an area other than an area of the adhering layer 401 occupied by the conductive particle layers 402. The conductive particle layers 402 may be interposed between the electrode terminals 204 and the first terminals 212a, and may electrically connect the electrode terminals 204 and the first terminals 212a together when compressed.

The insulative members 403 may be provided by coating the conductive particle layers 402 with insulation films, for example. When the electrode terminals 204 and the first terminals 212a are compressed, the insulation films may be destroyed between the electrode terminals 204 and the first terminals 212a.

To connect the second terminals 212a with the electrode terminals 204, the ACF 400 may be interposed therebetween when compressed. The insulative films coated on exterior surfaces of the conductive particle layers 402 may then be exploded by the pressure, and thus, the electrode terminals 204 and the second terminals 212a may be electrically connected to each other. Conductive particle layers 402 distributed in an area other than the space between the electrode terminals 204 and the second terminals 212a may remain as the insulating members 403, in which the insulative films may be kept.

In an alternative exemplary embodiment, as illustrated in FIG. 5, the connecting member 301 may be a non-conductive film 500 that may have protrusions 503 interposed between the electrode terminals 204 and the second terminals 212a in order to electrically connect them together.

The non-conductive film 500 may further include an adhering layer 501 formed of polymer resin, for example, and non-conductive particles 502 distributed in the adhering layer 501. The protrusions 503 may be formed of a conductive material and may have cross-section that may become smaller in a direction from the second terminals 212a to the electrode terminals 204. It should be appreciated that the protrusions 503 may be in other cross-sections beside the ones mentioned above.

When the electrode terminals 204 and the second terminals 212a are compressed with the non-conductive film 500 interposed therebetween so as to be connected with each other, the protrusions 503 having the downwardly narrowing cross-sections may penetrate the adhering layer 501, so that the electrode terminals 204 and the second terminals 212a may be electrically connected with each other. An area of the adhering layer 501 (area other than the protrusions 503) may be kept insulative by the non-conductive particles 502 scattered within the adhering layer 501.

It should be appreciated that other configurations of the non-conductive film 500 may be interposed between the electrode terminals 204 and the second terminals 212a.

Referring back to FIG. 3, the area where the electrode terminals 204 and the second terminals 212a may be connected together by the connecting member 301 may be enclosed by an enclosing material 302, such as, for example, silicon. The enclosing material 302 may be provided on a portion of a sidewall of the first substrate 101 to a portion of the second substrate 102 provided in the non-display area 202. Thereafter, the enclosing material 302 may then be hardened.

The electrode terminals 204 may be divided into several groups, and a short-circuit preventing unit (not shown) may be installed between the electrodes so as to prevent and/or reduce a short circuit.

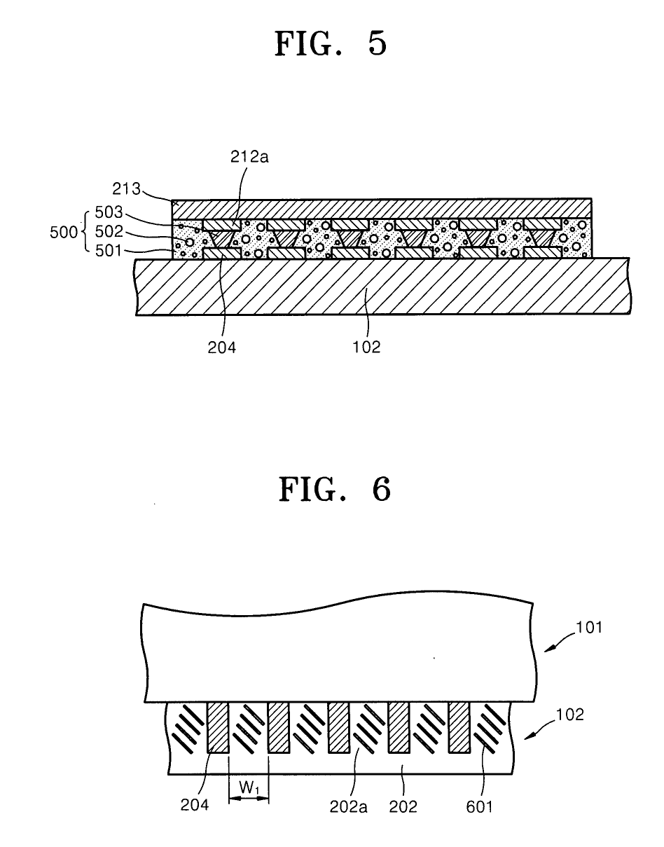

FIG. 6 illustrates an enlarged view of an area where short-circuit preventing unit 601 may be arranged in accordance to an exemplary embodiment.

Referring to FIG. 6, an edge of the second substrate 102 may be exposed outside an area where the first and second substrates 101 and 102 overlap each other, thereby forming the non-display area 202. A plurality of electrode terminals 204 may be arranged on the non-display area 202.

The electrode terminals 204 may be arranged at intervals of a width W1. However, it should be appreciated that the width may vary according to the size of the first terminals 212a. The short-circuit preventing units 601 may be installed in areas 202a between each of the electrode terminals 204. The short-circuit preventing units 601 may have surface roughness and may also widen the intervals between the electrode terminals 204.

In an exemplary embodiment, the surface roughness may be approximately 2 to 13 micrometers. It should be appreciated that a surface roughness less than about 2 micrometers may weaken an effect where intervals between the electrode terminals 204 are widened; and a surface roughness more than about 13 micrometers may destroy the second substrate 102 due to the excessive roughness. The vertical length of each of the short-circuit preventing units 601 may be shorter than that of each of the electrode terminals 204.

Although the above exemplary embodiment describes the short-circuit preventing units 601 having shorter vertical lengths than each of the electrode terminals, it should be appreciated that other dimensions may be employed.

Accordingly, a short circuit may be prevented because the intervals between the electrode terminals 204 may be widened by the short-circuit preventing units 204. Even if a conductive material, e.g., silver, that may be a major component of the electrode terminals 204 may be ionized due to the humidity in the air, the short-circuit preventing units may reduce and/or prevent short circuit.

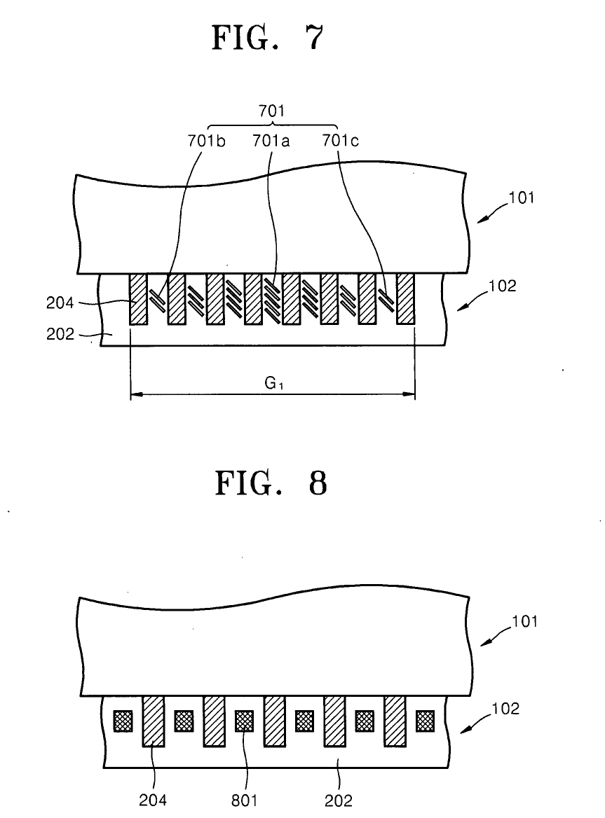

FIG. 7 illustrates an enlarged view of an area where short-circuit preventing unit 701 may be arranged according to another exemplary embodiment.

Referring to FIG. 7, the plurality of electrode terminals 204 may be arranged on the non-display area 202 and divided into groups. A plurality of electrode terminals 204 may be arrayed in an electrode terminal group G₁.

The short-circuit preventing unit 701 may include a plurality of short-circuit preventing units 701a, 701b, 701c. The short-circuit preventing unit 701a having a high surface roughness may be formed between electrode terminals 204 arranged at a center portion of the group G₁, which may be relatively frequently driven. The short-circuit preventing units 701b and 701c, each having a high surface roughness, may be formed between electrode terminals 204 arranged at both end portions of the group G₁, which may be relatively rarely driven. The surface roughness of the short-circuit preventing unit 701 may gradually increase, e.g., in the direction of the edges of the group G₁ to the center thereof. In other words, the short-circuit preventing unit 701a may have a higher surface roughness than the short-circuit preventing units 701b and 701c.

Although the above exemplary embodiment describes the short-circuit preventing units 701 as having higher surface roughness at the center portion of group G₁, it should be appreciated that other configurations may be employed, e.g., surface roughness being higher at edges of the group G₁.

Accordingly, even when a conductive material, e.g., silver, of the electrode terminals 204 migrates, the intervals between electrode terminals 204 may be widened, so that a short circuit between adjacent electrode terminals 204 may be prevented and/or reduced.

FIG. 8 illustrates an enlarged view of an area where short-circuit preventing units 801 may be arranged according to another exemplary embodiment.

Referring to FIG. 8, short-circuit preventing units 801 may be formed between each of the plurality of electrode terminals 204 arranged on the non-display area 202. The short-circuit preventing units 801 may be grooves formed between the electrode terminals 204. Therefore, the intervals between the electrode terminals 204 may be widened, so that silver migration may be prevented and/or reduced.

Although the above exemplary embodiment describes the short-circuit preventing units 801 as grooves, it should be appreciated that other forms may be employed, e.g., channels.

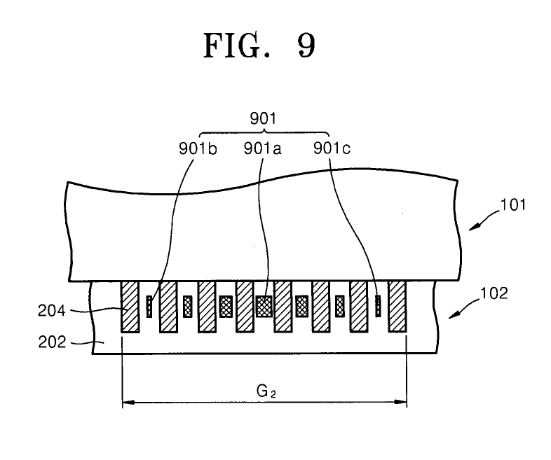

FIG. 9 illustrates an enlarged view of an area where short-circuit preventing unit 901 may be arranged according to another exemplary embodiment.

Referring to FIG. 9, the plurality of electrode terminals 204 may be arranged on the non-display area 202 and divided into groups. A plurality of electrode terminals 204 may be arrayed in an electrode terminal group G₂.

The short-circuit preventing unit 901 may include a plurality of short-circuit preventing units 901a, 901b, 901c. The short-circuit preventing unit 901a, having the shape of a wide groove, may be formed between electrode terminals 204 arranged at a center portion of the group G₂, which may be relatively frequently driven. The short-circuit preventing units 901b and 901c, each having the shape of a narrow groove, may be formed between electrode terminals 204 arranged at both end portions of the group G₂, which may be relatively rarely driven. The short-circuit preventing unit 901 may include grooves that may gradually increase in size, e.g., increase in size from edges of the group G₂ to a center thereof. In other words, the short-circuit preventing unit 901a may have a larger sized groove than the grooves of the short-circuit preventing units 901b and 901c.

Although the above exemplary embodiment describes the short-circuit preventing unit 901 as having a larger size groove at the center portion of group G₂ than the edge portion of group G₁, it should be appreciated that other configurations may be employed, e.g., size of the grooves of the short-circuit preventing units being larger at the edges of the group G₂.

Accordingly, even when a conductive material, e.g., silver, of the electrode terminals 204 may be migrated, the intervals between electrode terminals 204 may be widened, so that a short circuit between adjacent electrode terminals 204 may be prevented and/or reduced.

One skilled in the art should appreciate that the short-circuit preventing units 601 through 901, having the above-described roughness and/or a groove shape, may be formed either by etching method before forming the electrode terminals 204 and/or using a sand blasting method simultaneously when forming the barrier rib structure 114.

An operation of the PDP 100 having the structure of the exemplary embodiments will now be described with reference to FIG. 1.

When a predetermined pulse voltage is applied from an external power source between the address electrodes 112 and the Y electrodes 105, discharge cells emitting light may be selected. Wall charges may be accumulated on the inner lateral surfaces of the selected discharge cells.

When a positive voltage is then applied to the X electrodes 104 and a voltage higher than the positive voltage is applied to the Y electrodes 105, the wall charges may be moved by a difference between voltages applied to the X and Y electrodes 104 and 105.

While the moving wall charges are colliding with the atoms of the discharge gas within the discharge cells, discharge may be generated, and thus, plasma may be produced. The discharge may start from discharge gaps between the X and Y electrodes 104 and 105, where a relatively strong electrical field may be formed, and may extend to the outside of the X and Y electrodes 104 and 105.

After the generation of the discharge, e.g., when the voltage difference between the X and Y electrodes 104 and 105 is lowered than a discharge voltage, no more discharge may be generated, and thus, spatial charges and wall charges may be formed within the discharge cells.

At this time, when the polarities of the voltages applied to the X and Y electrodes 104 and 105 are switched to each other, discharge may be regenerated due to the wall charges. Accordingly, when the polarities of the voltages applied to the X and Y electrodes 104 and 105 are immediately switched to each other, the initial discharge generation process may be repeated. Thus, discharge may be stably generated while repeating the above process.

UV light generated due to discharge may excite the phosphor materials of the phosphor layers 117 within the discharge cells. As a result, visible light may be generated. The visible light may be emitted through the discharge cells, thereby providing still images or moving images.

During the driving of the PDP 100, even when a conductive material, e.g., silver, of the address electrodes 17 migrates, a short circuit may be prevented between adjacent address electrodes 112 due to the formation of the short-circuit preventing units between the address electrodes 112.

Accordingly, intervals between the electrode terminals of the PDP device according to exemplary embodiments may be widened by the short-circuit preventing units, so that a short circuit between adjacent electrode terminals may be prevented and/or reduced.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed:

1. A plasma display panel device, comprising:
a substrate;
discharge electrodes arranged on the substrate; and
a plurality of short-circuit preventing units formed between terminals of each of the discharge electrodes, so as to prevent a short circuit between the terminals of adjacent discharge electrodes.

2. The plasma display panel device as claimed in claim 1, wherein the short-circuit preventing units includes a surface roughness.

3. The plasma display panel device as claimed in claim 2, wherein the surface roughness is approximately 2 to 13 micrometers.

4. The plasma display panel device as claimed in claim 2, wherein one short-circuit preventing unit arranged near a center region of a group of discharge electrodes has a higher surface roughness than short-circuit preventing units arranged on an edge region of the discharge electrode group.

5. The plasma display panel device as claimed in claim 4, wherein the surface roughness of the short-circuit preventing unit at the edge region of the discharge electrode group gradually increases toward the center region of the discharge electrode group.

6. The plasma display panel device as claimed in claim 1, wherein the short-circuit preventing units are grooves formed between the terminals of adjacent discharge electrodes.

7. The plasma display panel device as claimed in claim 6, wherein one groove near a center region of a group of discharge electrode is wider than grooves near an edge region of the discharge electrode group.

8. The plasma display panel device as claimed in claim 7, wherein the width of the grooves at the edge region of the discharge electrode group gradually increases toward the center region of the discharge electrode group.

9. The plasma display panel device as claimed in claim 1, wherein the short-circuit preventing units are formed using one of an etching method and a sand blasting method.

10. The plasma display panel device as claimed in claim 1, wherein a vertical length of each of the short preventing units is smaller than a vertical length of each of the discharge electrodes.

11. A plasma display panel device, comprising:
a panel including a first substrate and a second substrate;
a plurality of discharge electrode pairs between the first and second substrates;
signal transferring units electrically connected to terminals of the discharge electrode pairs; and
short-circuit preventing units formed between the terminals of each of the discharge electrodes in order to prevent a short circuit between the terminals of adjacent discharge electrodes,
wherein the panel is divided into a display area that displays an image due to discharge of the discharge electrodes pairs, and a non-display area outside the display area, the non-display area includes the terminals of the discharge electrodes pairs that electrically connect to the terminals of the signal transferring units

12. The plasma display panel device as claimed in claim 11, wherein the short-circuit preventing units includes a surface roughness.

13. The plasma display panel device as claimed in claim 12, wherein the surface roughness is approximately 2 to 13 micrometers.

14. The plasma display panel device as claimed in claim 12, wherein one short-circuit preventing unit arranged near a center region of a group of discharge electrodes has a higher surface roughness than short-circuit preventing units arranged near an edge region of the discharge electrode group.

15. The plasma display panel device as claimed in claim 14, wherein the surface roughness of the short-circuit preventing unit at the edge region of the discharge electrode group gradually increases toward the center region of the discharge electrode group.

16. The plasma display panel device as claimed in claim 11, wherein the short-circuit preventing units are grooves formed between the terminals of adjacent discharge electrodes.

17. The plasma display panel device as claimed in claim 16, wherein one groove near a center region of a discharge electrode group is wider than grooves on an edge region of the discharge electrode group.

18. The plasma display panel device as claimed in claim 16, wherein the width of the grooves at the edge region of the discharge electrode group gradually increases toward the center region of the discharge electrode group.

19. The plasma display panel device as claimed in claim 11, wherein the short-circuit preventing units are formed using one of an etching method and a sand blasting method.

20. The plasma display panel device as claimed in claim 11, wherein a vertical length of each of the short preventing units is smaller than a length of each of the discharge electrodes.
